(19) United States
(12) Patent Application Publication
(10) Pub. No.: US 2019/0159538 A1
(43) Pub. Date: May 30, 2019

(54) ARTIFICIAL EYELASHES AND METHOD OF MANUFACTURING THE SAME

(71) Applicant: M&C ELECTRONICS VINA COMPANY LIMITED, Bac Ninh Province (VN)

(72) Inventors: Chung Hyun ROH, Bac Ninh Province (VN); Jeo Hoon SEO, Bac Ninh Province (VN)

(21) Appl. No.: 15/824,159

(22) Filed: Nov. 28, 2017

(51) Int. Cl. A41G 5/02; B23K 26/38; B23K 26/402

(52) U.S. Cl. CPC A41G 5/02; B23K 26/402; B23K 26/38

(57) ABSTRACT

Disclosed are artificial eyelashes including a first shape a first shape formed by cutting out a plurality of first strands integrated with a first base portion connected to one end of the first strands to support the first strands from a first plastic sheet having a certain thickness and a second shape formed by cutting out a plurality of second strands integrated with a second base portion connected to one end of the second strands to support the second strands from a second plastic sheet having a certain thickness. Here, one surface of the first base portion is adhered to one surface of the second base portion.

### FIELD

The present invention relates to artificial eyelashes and a method of manufacturing the artificial eyelashes.

### BACKGROUND

Generally, artificial eyelashes refer to eyelashes formed by using artificial hairs or human hairs and attached to eyelashes.

FIGS. 1A, 1B, 1C and 1D are views schematically illustrating an existing method of manufacturing artificial eyelashes. First, strands of eyelash formed of artificial hairs or human hairs are prepared (FIG. 1A), the strands of eyelash are tied up and fixed to a support thread one by one (FIG. 1B), a curve shape is formed and processed with details (FIG. 1C), and artificial eyelashes are completed (FIG. 1D).

In the above existing method of manufacturing artificial eyelashes, operations of FIGS. 1B and 1C are manually performed by humans such that a large amount of operation time is consumed and quality and productivity depend on only proficiency of workers.

Accordingly, a manufacturing method capable of wholly or partially automating a manufacturing process and manufacturing artificial eyelashes with consistent quality in a reduced manufacturing time has been required.

Also, since existing artificial eyelashes shown in FIG. 1 includes strands of eyelash arranged along a single line, it is difficult to provide a three-dimensional effect and there is a limitation in embodying various and distinctive designs.

### SUMMARY

It is an aspect of the present invention to provide artificial eyelashes and a method of manufacturing the same, capable of wholly or partially automating a manufacturing process and reducing a manufacturing time.

It is another aspect of the present invention to provide artificial eyelashes and a method of manufacturing the same, capable of providing a three-dimensional effect and adequate for embodying various and distinctive designs.

According to one aspect of the present invention, artificial eyelashes include a first shape formed by cutting out a plurality of first strands integrated with a first base portion connected to one end of the first strands to support the first strands from a first plastic sheet having a certain thickness and a second shape formed by cutting out a plurality of second strands integrated with a second base portion connected to one end of the second strands to support the second strands from a second plastic sheet having a certain thickness. Here, one surface of the first base portion is adhered to one surface of the second base portion.

The artificial eyelashes may further include at least one strand of monofilament adhered to a side surface or an upper surface of the first and second base portions.

The monofilament may be deformed to be in a circular arc shape.

The first strands and the second strands may be bent in the same direction.

A pattern of the first strands may be different from a pattern of the second strands.

A direction in which the first strands are stretched from the first base portion may be different from a direction in which the second strands are stretched from the second base portion.

A color of the first plastic sheet may be different from a color of the second plastic sheet.

According to another aspect of the present invention, a method of manufacturing artificial eyelashes includes forming a first shape by cutting out a plurality of first strands integrated with a first base portion connected to one end of the first strands to support the first strands from a first plastic sheet having a certain thickness, forming a second shape by cutting out a plurality of second strands integrated with a second base portion connected to one end of the second strands to support the second strands from a second plastic sheet having a certain thickness, and forming a third shape, in which the first shape and second shape are combined, by adhering one surface of the first base portion to one surface of the second base portion.

The method may further include adhering at least one strand of monofilament to a side surface or an upper surface of the first and second base portions.

The method may further include deforming the monofilament to be in a circular arc shape.

The method may further include applying an adhesive to the monofilament.

The method may further include rolling up the third shape in an arrangement direction of the first and second strands such that the first and second strands are bent.

A pattern of the first strands may be different from a pattern of the second strands.

A direction in which the first strands are stretched from the first base portion may be different from a direction in which the second strands are stretched from the second base portion.

The forming of the first shape and the forming of the second shape may be performed by using a laser cutter.

The laser cutter may use one of an ultraviolet (UV) laser, a CO2 laser, and a fiber laser.

The forming of the first shape and the forming of the second shape may be performed by using a cutting press.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1A, 1B, 1C and 1D are views schematically illustrating an existing method of manufacturing artificial eyelashes;

FIG. 2 illustrates a shape in which a plurality of first strands are formed by cutting out a certain area in a first plastic sheet;

FIG. 3 illustrates a shape in which an edge line of eyelashes is formed by cutting one side of the plurality of first strands;

FIG. 4 illustrates a first shape in which the plurality of first strands and a first base portion are integrated and which is obtained by cutting the first plastic sheet;

FIG. 5 illustrates a shape in which a plurality of second strands are formed by cutting a certain area in a second plastic sheet;

FIG. 6 illustrates a shape in which an edge line of eyelashes is formed by cutting one side of the plurality of second strands;

FIG. 7 illustrates a second shape in which the plurality of second strands and a second base portion are integrated and which is obtained by cutting the second plastic sheet;

FIG. 8 illustrates a third shape formed by combining the first shape of FIG. 4 with the second shape of FIG. 7;

FIG. 9 illustrates a shape in which the third shape of FIG. 8 is rolled up in a direction of arrangement of the first and second strands;

FIG. 10 illustrates a shape of the curled first and second strands as a result of going through the operation of FIG. 9;

FIG. 11 illustrates a shape in which a monofilament 60 adhered to sides of the first and second base portions 22 and 42 of FIG. 10;

FIG. 12 illustrates a shape of the monofilament 60 in a structure of FIG. 11 and modified into a circular arc shape; and

FIGS. 13A, 13B and 13C illustrate shapes according to a modified example of the shapes shown in FIGS. 4, 7, and 8.

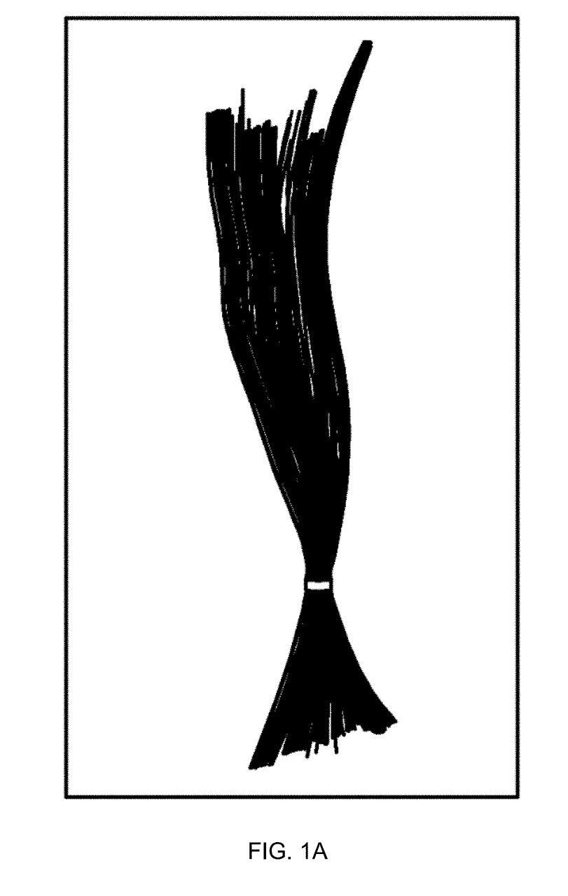

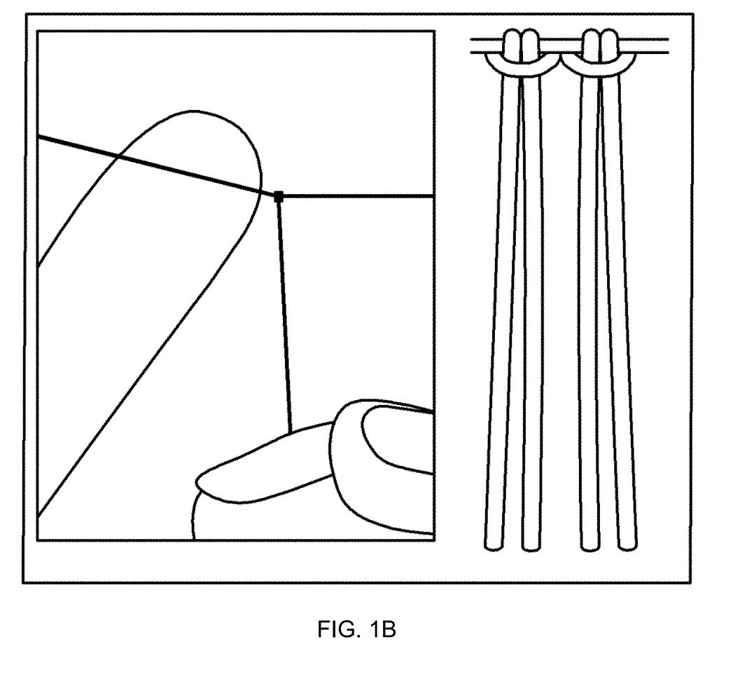

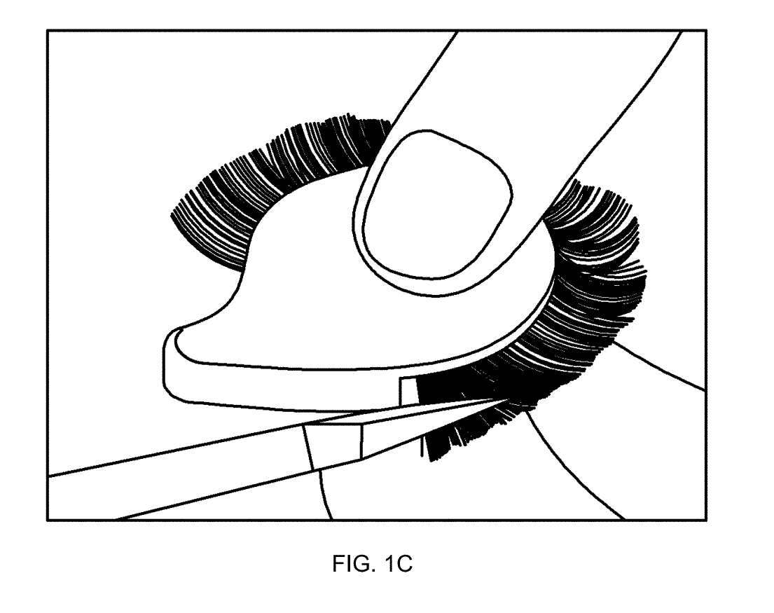

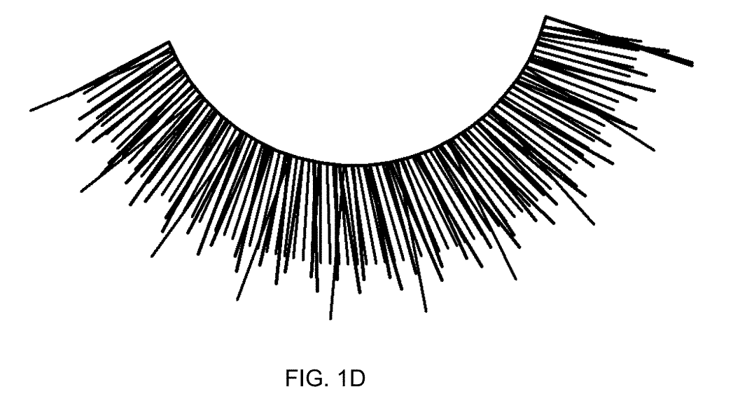

### DETAILED DESCRIPTION

Hereinafter, exemplary embodiments of the present invention will be described in detail with reference to the drawings. Throughout the following description and attached drawings, substantially like components will be referred to as like reference numerals and a repeated description thereof will be omitted. Also, throughout the description of the embodiments of the present invention, a detailed explanation of well-known functions and components of the related art will be omitted when it is deemed that they may unnecessarily obscure the essence of the present invention.

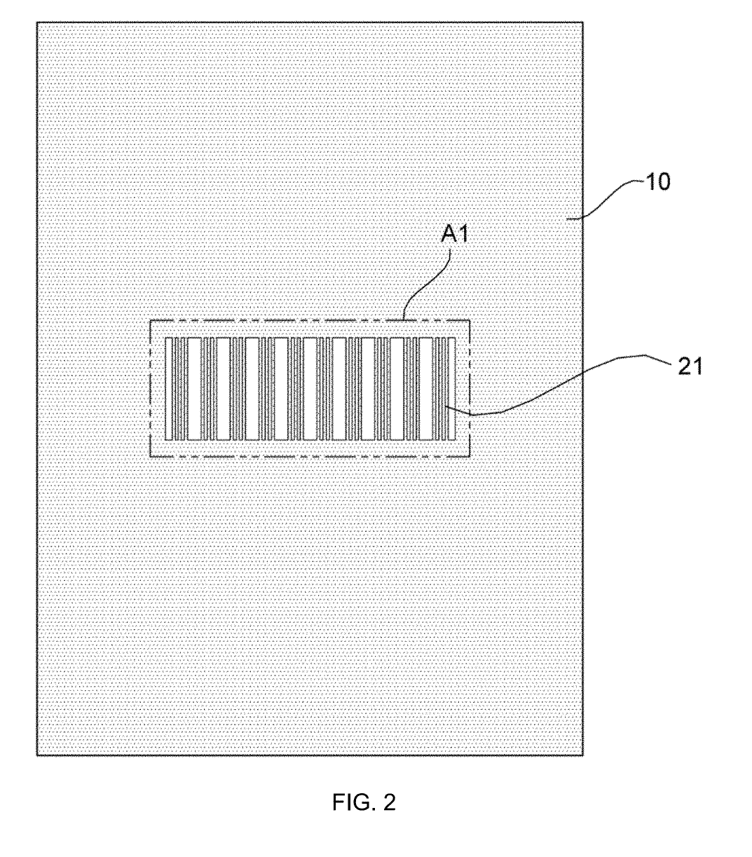

FIGS. 2 to 12 are views illustrating artificial eyelashes and a method of manufacturing the same according to one embodiment of the present invention.

According to one embodiment of the present invention, plastic sheets 10 and 30 with certain thicknesses are used as a material of the artificial eyelashes. As the material of the plastic sheets 10 and 30, there are, for example, polyethylene terephthalate (PET), polyethylene (PE), nylon, polyvinylchloride (PVC), polypropylene (PP), and the like. In addition, an echo-friendly material such as protein and the like may be used. In consideration of throwing away artificial eyelashes after a short-term use, artificial eyelashes formed of an echo-friendly material such as protein and the like may contribute to protection of environment.

Thicknesses of the plastic sheets 10 and 30 may be about 0.05 to 0.15 mm. Depending on a color of eyelashes to be manufactured, black sheets may be used or plastic sheets of various other colors may be used.

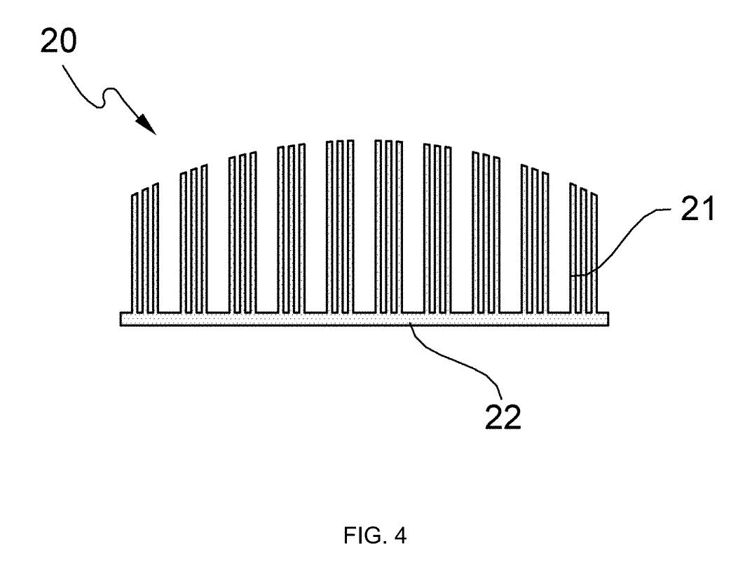

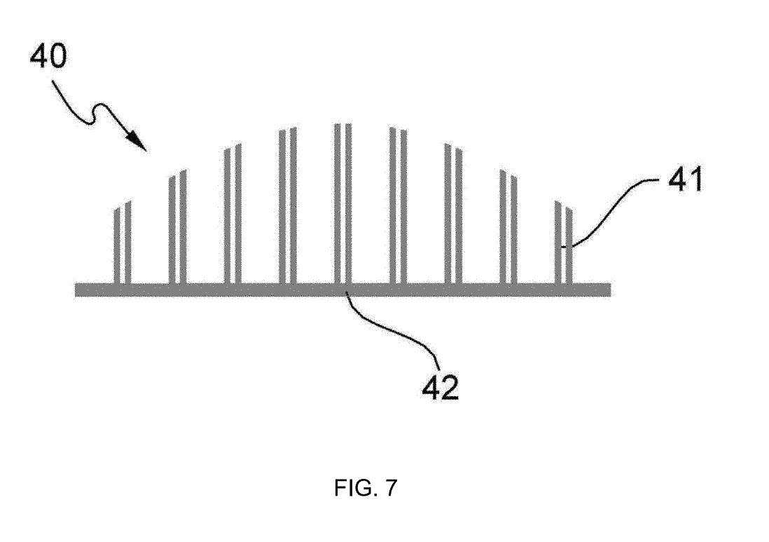

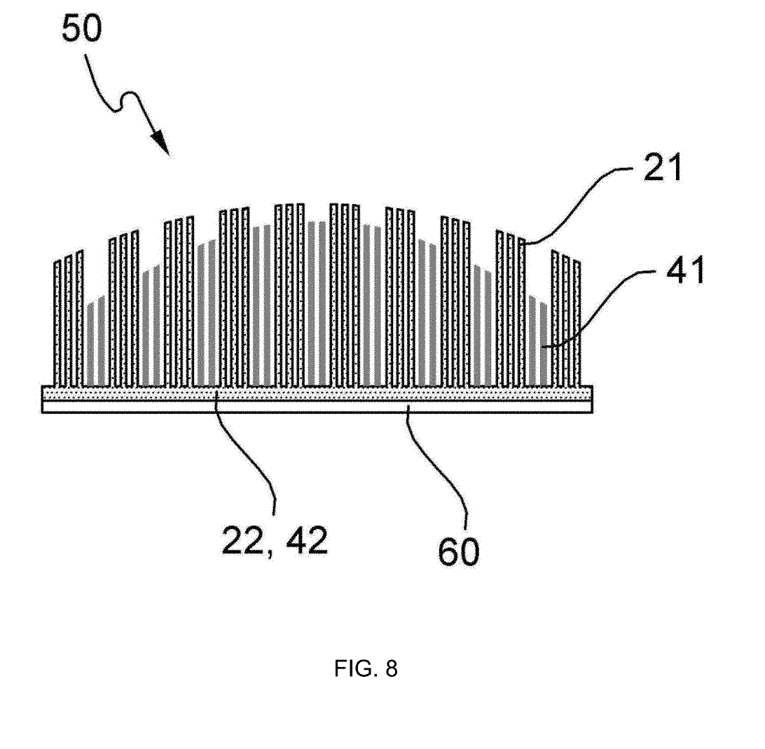

In one embodiment of the present invention, a first shape 20, as shown in FIG. 4, in which a plurality of first strands 21 and a first base portion 22 connected to one end of the first strands 21 to support the first strands 21 are integrated, is formed by cutting a first plastic sheet 10. A second shape 40, as shown in FIG. 7, in which a plurality of second strands 41 and a second base portion 42 connected to one end of the second strands 41 to support the second strands 41 are integrated, is formed by cutting a second plastic sheet 30. With the first shape 20 of FIG. 4 and the second shape 40 of FIG. 7 formed as described above, as shown in FIG. 8, artificial eyelashes with two different layers of the first strands 21 and the second strands 41 are manufactured by adhering one surface of the first base portion 22 of the first shape 20 to one surface of the second base portion 42 of the second shape 40 by using adhesives. Since colors of the first strands 21 and the second strands 41 naturally depend on colors of the first plastic sheet 10 and the second plastic sheet 30, an eyelash design with mixed two colors may be embodied by using the first plastic sheet 10 and the second plastic sheet 30 in different colors. Of course, the first plastic sheet 10 and the second plastic sheet 30 may have the same color.

The plastic sheets 10 and 30 may be cut by using a laser cutter or a cutting press. In the case of laser cutter, a laser cutter using an ultraviolet (UV) laser, a CO2 laser, a fiber laser, and the like may be used.

In the case of UV laser cutter, a capacity may be 5 to 10 W, a speed may be about 2 m/sec, and a width of laser may be 10 to 25 μm.

In the case of CO2 laser cutter, a capacity may be 100 to 300 W, a speed may be about 2 m/sec, and a width of laser may be 100 to 150 μm.

In the case of fiber laser cutter, a capacity may be 20 to 30 W, a speed may be about 2 m/sec, and a width of laser may be 100 to 150 μm.

Among them, since the UV laser does not generate heat at a cut section such that there is no deformation of a product, a cut state is relatively excellent, and a width of laser is small, the UV laser may be used in one embodiment of the present invention.

To form the first shape 20 shown in FIG. 4 by cutting the first plastic sheet 10, first, the plurality of first strands 21 are formed by cutting a certain area A1 of the first plastic sheet 10, as shown in FIG. 2. Here, the plurality of first strands 21 are some of strands of eyelash for forming artificial eyelashes (the other thereof is the second strands 41), and a width and an interval thereof are determined according to artificial eyelashes to be manufactured and may be generally 0.05 to 0.15 mm to provide an effect of human hairs. Also, a pattern of the first strands 21 (for example, a width, an interval, an arrangement pattern, a stretch direction, a shape, and the like) may be different from a pattern of the second strands 41. As described above, since the laser cutter or the cutting press is used, the pattern of the first strands 21 such as the width, the interval, and the like may be desirably formed as much as wanted according to decorative and functional needs for the artificial eyelashes as much as the laser cutter or the cutting press supports.

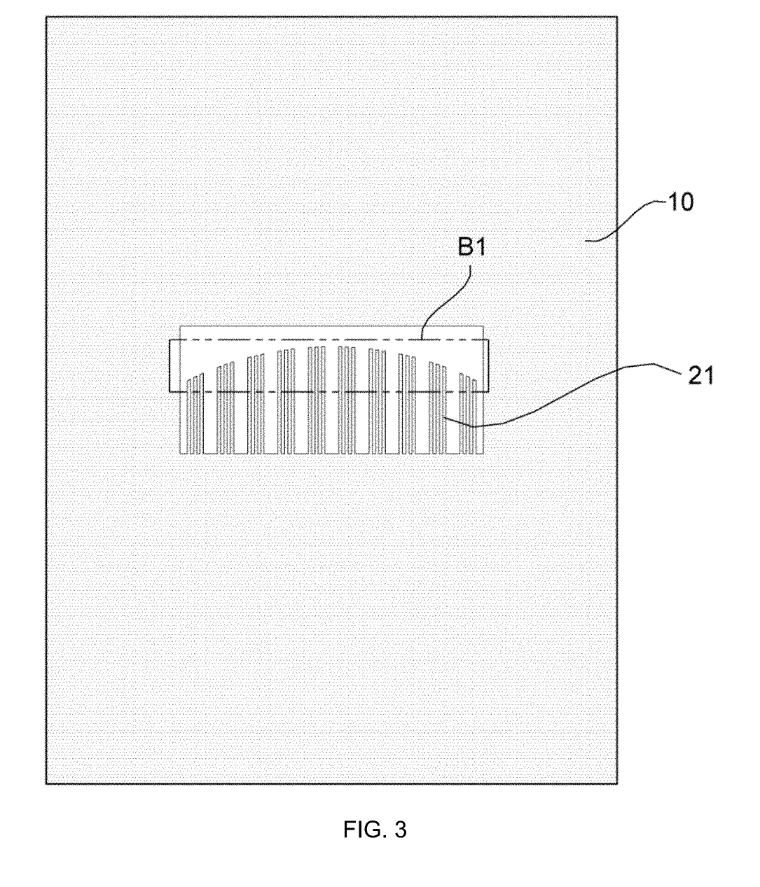

Also, as shown in FIG. 3, an eyelash edge line B1 is formed by cutting one side of the plurality of first strands 21. Although a circular arc shape which is a typical eyelash edge line is shown in FIG. 3, since the laser cutter or the cutting press is used as described above, a shape of eyelash edge line may be formed as much as desirable according to decorative and functional needs for the artificial eyelashes.

When only the first strands 21 and the first base portion 22 are left and other parts are removed by cutting from the first plastic sheet 10 in which the plurality of first strands 21 and the eyelash edge line B1 are formed, the first shape 20 including the plurality of first strands 21 and the first base portion 22 connected to one end of the first strands 21 to support the first strands 21 is obtained as shown in FIG. 4. Here, the first base portion 22 is a part which supports the plurality of first strands 21 and simultaneously to which a monofilament which will be described below is attached and has a width of about 0.5 to 2.0 mm.

Also, to add naturalness of real eyelashes, the plurality of first strands 21 may be processed to be rounded with a pointed end through a grinding process. Here, a coarse level may be about #80 to #400.

In the embodiment of the present invention, the eyelash edge line B1 is formed by cutting one side of the plurality of first strands 21 as shown in FIG. 3 before the first shape 20 including the plurality of first strands 21 integrated with the first base portion 22 is separated from the first plastic sheet 10. However, on the other hand, the eyelash edge line B1 may be formed by cutting one side of the plurality of first strands 21 after the first shape 20 including the plurality of first strands 21 integrated with the first base portion 22 is separated from the first plastic sheet 10.

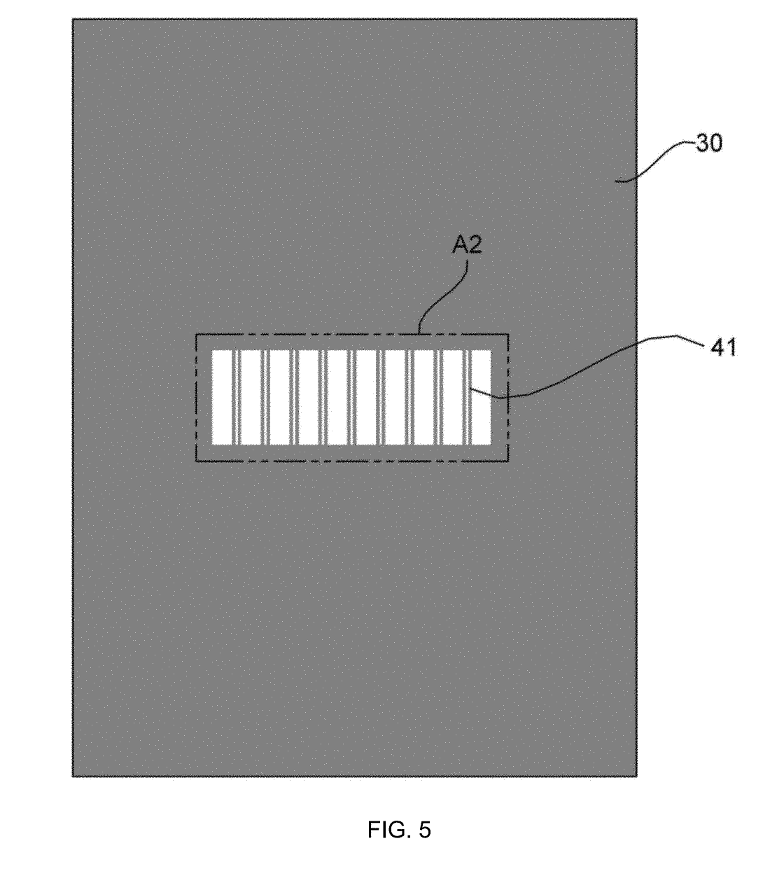

Now, to form the second shape 40 shown in FIG. 7 by cutting the second plastic sheet 30, first, the plurality of second strands 41 are formed by cutting out a certain area A2 of the second plastic sheet 30, as shown in FIG. 5. Here, the plurality of second strands 41 are some of strands of eyelash for forming artificial eyelashes (the other thereof is the first strands 21), and a width and an interval thereof are determined according to artificial eyelashes to be manufactured and may be generally 0.05 to 0.15 mm to provide an effect of human hairs. Also, a pattern of the second strands 41 (for example, a width, an interval, an arrangement pattern, a stretch direction, a shape, and the like) may be different from a pattern of the first strands 21. As described above, since the laser cutter or the cutting press is used, the pattern of the second strands 21 such as the width, the interval, and the like may be desirably formed as much as wanted according to decorative and functional needs for the artificial eyelashes as much as the laser cutter or the cutting press supports.

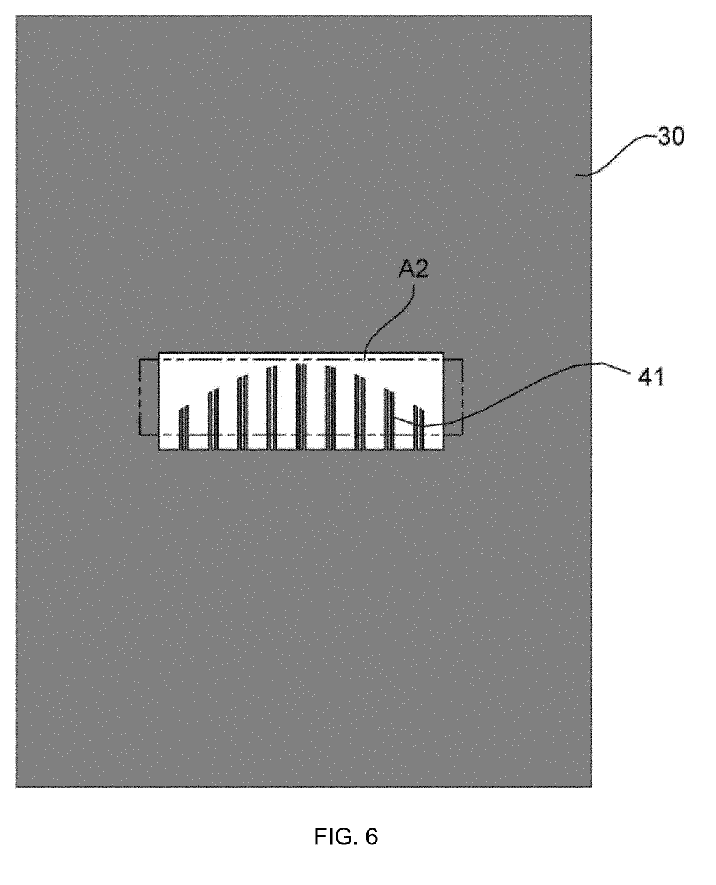

Also, as shown in FIG. 6, an eyelash edge line B2 is formed by cutting one side of the plurality of second strands 41. Although a circular arc shape which is a typical eyelash edge line is shown in FIG. 6, since the laser cutter or the cutting press is used as described above, a shape of eyelash edge line may be formed as much as desirable according to decorative and functional needs for the artificial eyelashes. Also, the eyelash edge line B2 of the second shape 40 may be different from the eyelash edge line B1 of the first shape 20. For example, referring to FIGS. 3 and 6, although both the eyelash edge line B1 and the eyelash edge line B2 have a circular arc shape, curved shapes thereof are different from each other and the eyelash edge line B2 is formed to be deeper such that the second strands 41 may be formed to be shorter than the first strands 21.

When only the second strands 41 and the second base portion 42 are left and other parts are removed by cutting from the second plastic sheet 30 in which the plurality of second strands 41 and the eyelash edge line B2 are formed, the second shape 40 including the plurality of second strands 41 and the second base portion 42 connected to one end of the second strands 41 to support the second strands 41 is obtained as shown in FIG. 7. Here, the second base portion 42 is a part which supports the plurality of second strands 41 and simultaneously to which a monofilament which will be described below is attached and has a width of about 0.5 to 2.0 mm.

Also, to add naturalness of real eyelashes, the plurality of second strands 41 may be processed to be rounded with a pointed end through a grinding process. Here, a coarse level may be about #80 to #400.

In the embodiment of the present invention, the eyelash edge line B2 is formed by cutting one side of the plurality of second strands 41 as shown in FIG. 6 before the second shape 40 including the plurality of second strands 41 integrated with the second base portion 42 is separated from the second plastic sheet 30. However, on the other hand, the eyelash edge line B2 may be formed by cutting one side of the plurality of second strands 41 after the second shape 40 including the plurality of second strands 41 integrated with the second base portion 42 is separated from the second plastic sheet 30.

When the first shape 20 of FIG. 4 and the second shape 40 of FIG. 7 are obtained as described above, as shown in FIG. 8, a third shape 50 formed by combining the first shape 20 with the second shape is obtained by adhering one surface of the first base portion 22 of the first shape 20 to one surface of the second base portion 42 of the second shape 40 by using adhesives. Since the first strands 21 and the second strands 41 are formed of different layers in the third shape 50, a three-dimensional effect for similarity with real eyelashes or an aesthetic effect may be provided.

Also, for example, referring to FIGS. 4, 7, and 8, the pattern of the first strands 21 and the pattern of the first strands may be formed to be alternately arranged without overlapping between the first strands 21 of the first shape 20 and the second strands 41 of the second shape 40 when the first shape 20 and the second shape 40 overlap each other. According to one embodiment of the present invention, since the patterns or the eyelash edge lines of the first strands 21 and the second strands 41 may be formed in various desirable shapes by using the laser cutter or cutting press as described above, the patterns or the eyelash edge lines of the first strands 21 and the second strands 41 may be formed in mutually different shapes such that various and distinctive designs of artificial eyelashes may be embodied.

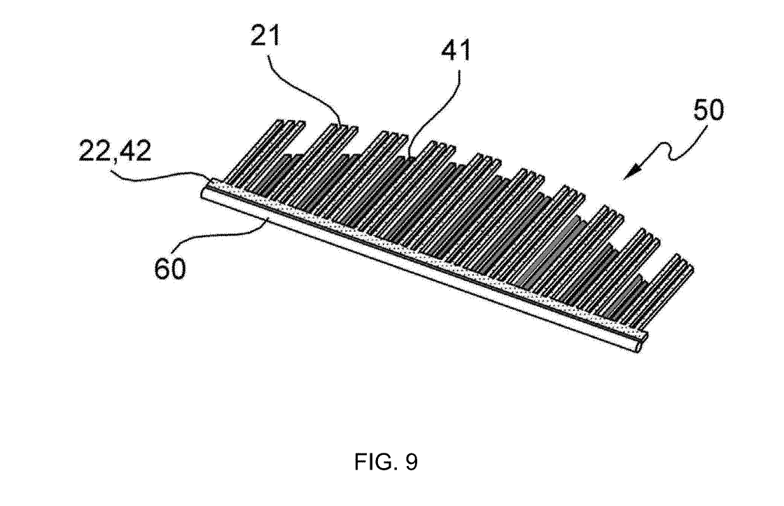

When the third shape 50 shown in FIG. 3 is obtained, a monofilament 60 is adhered to a longitudinal side surface or an upper surface of the first and second base portions 22 and 42 of the third shape 50 as shown in FIG. 9. A length of the monofilament 60 may correspond to lengths of the first and second base portions 22 and 42 and a diameter thereof may be about 0.1 to 0.3 mm. One strand of monofilament 60 may be adhered or several strands of the monofilament 60 may be adhered according to a thickness to be formed. A material of the monofilament 60 may be PET, nylon, and the like, and a color thereof may be black or a transparent color or may be various other colors. Although a monofilament is generally used for a fishing line, a fishing net, and the like, a monofilament of the artificial eyelashes is used as a part attached to a human body in one embodiment of the present invention. As described above, in one embodiment of the present invention, since the artificial eyelashes are formed to be integrated by using the plastic sheets, the monofilament 60 is advantageous for adhesion with the plastic sheets. The first and second base portions 22 and 42 and the monofilament 60 may be adhered to each other, for example, by using a solventless polyurethane adhesive.

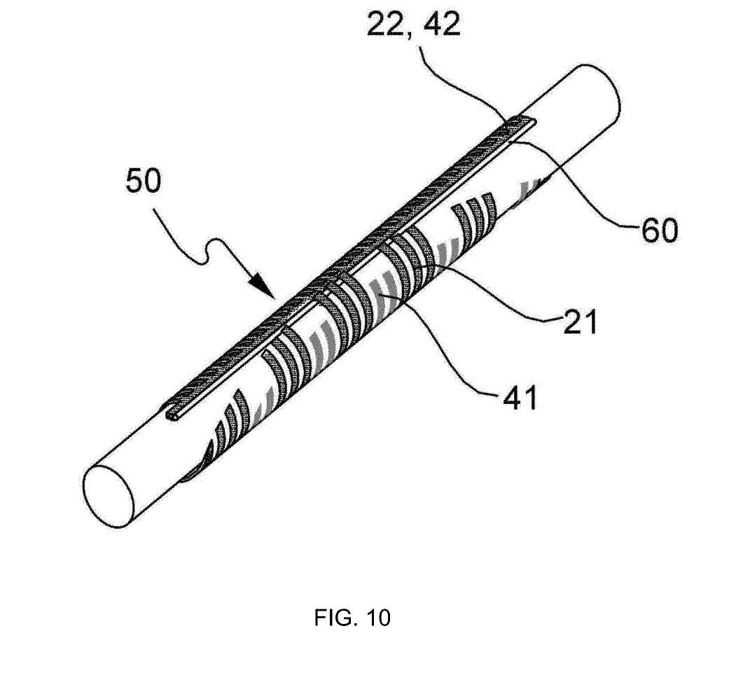

Now, to form curls like real eyelashes at the first strands 21 and the second strands 41, as shown in FIG. 10, the third shape 50 is rolled up in an arrangement direction of the first strands 21 and the second strands 41 to bend the first strands 21 and the second strands 41 in the same direction and then maintain a state thereof for a certain time. For this, as shown in the drawing, the third shape 50 may be attached on a cylindrical core and rolled up thereon.

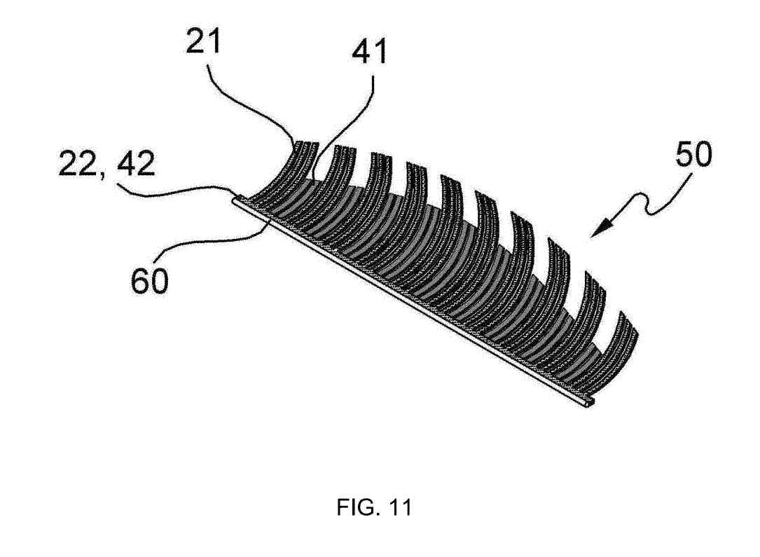

FIG. 11 illustrates a shape in which curls are formed at the first strands 21 and the second strands 41 as a result of going through the process of FIG. 10. Referring to FIG. 11, it may be seen that the first strands 21 and the second strands 41 are formed as two layers such that a three-dimensional effect is provided.

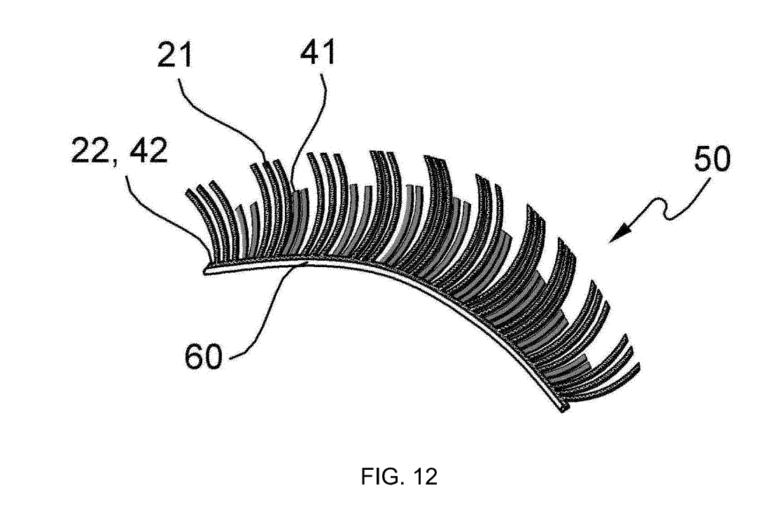

Next, as shown in FIG. 12, the monofilament 60 adhered to the first and second base portions 22 and 42 is deformed to be a circular arc shape to allow the first and second strands 21 and 41 to face an outside of the arc. Now, an adhesive for attachment to a human body is applied to the monofilament 60, the artificial eyelashes according to one embodiment of the present invention is completed.

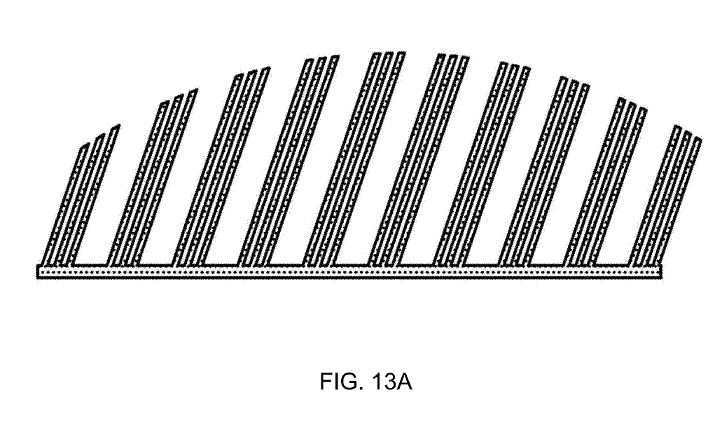

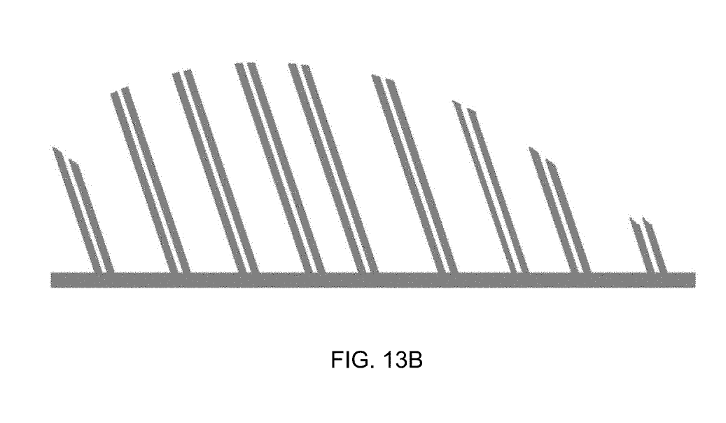

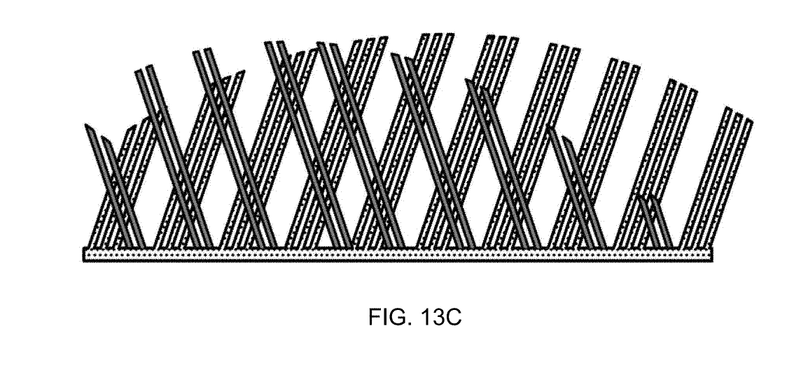

FIGS. 13A, 13B and 13C illustrate shapes according to a modified example of the shapes shown in FIGS. 4, 7, and 8.

Referring to FIGS. 13A, 13B and 13C, a direction in which first strands are stretched from a first base portion in a first shape (FIG. 13A) is formed to be different from a direction in which second strands are stretched from a second base portion in a second shape (FIG. 13B), and the first shape (FIG. 13A) and the second shape (FIG. 13B) may be combined as shown in FIG. 13C. As described above, according to one embodiment of the present invention, various and distinctive designs may be provided.

According to one embodiment of the present invention, a shape including a plurality of strands integrated with a base portion is formed by cutting a plastic sheet having a certain thickness by using a laser cutter or a cutting press such that an existing operation of strands of eyelash is manually tied up and fixed to a support thread one by one may be replaced by an automated method, an operation time may be significantly reduced, and a width, an interval, an edge line, and the like of strands of eyelash may be formed in a desirable shape as much as wanted. Also, a three-dimensional effect may be provided and various and distinctive designs may be provided by adhering and coupling a first shape and a second shape to a base portion.

According to the embodiments of the present invention, a process of manufacturing artificial eyelashes may be wholly or partially automated and a manufacturing time may be significantly reduced by forming a shape by cutting out a plurality of strands integrated with a base portion connected to one end of the plurality of strands to support the plurality of strands from a plastic sheet having a certain thickness.

Also, there are provided a three-dimensional effect and an effect of embodying various and distinctive designs by adhering one surface of a first base portion of a first shape to one surface of a second base portion of a second shape, which are formed as described above.

While the exemplary embodiments of the present invention have been described above, it should be appreciated by one of ordinary skill in the art that modifications may be made without departing from the essential features of the present invention. Therefore, the disclosed embodiments should be considered not in a limitative point of view but in a descriptive point of view. It should be appreciated that the scope of the present invention is defined by the claims not by the above description and includes all differences within the equivalent scope thereof.

What is claimed is:

1. An artificial eyelash comprising:
a first shape formed by cutting out a plurality of first strands integrated with a first base portion connected to one end of the first strands to support the first strands from a first plastic sheet having a certain thickness; and
a second shape formed by cutting out a plurality of second strands integrated with a second base portion connected to one end of the second strands to support the second strands from a second plastic sheet having a certain thickness,
wherein one surface of the first base portion is adhered to one surface of the second base portion.

2. The artificial eyelash of claim 1, further comprising at least one strand of monofilament adhered to a side surface or an upper surface of the first and second base portions.

3. The artificial eyelash of claim 2, wherein the monofilament is deformed to be in a circular arc shape.

4. The artificial eyelash of claim 1, wherein the first strands and the second strands are bent in the same direction.

5. The artificial eyelash of claim 1, wherein a pattern of the first strands is different from a pattern of the second strands.

6. The artificial eyelash of claim 5, wherein a direction in which the first strands are stretched from the first base portion is different from a direction in which the second strands are stretched from the second base portion.

7. The artificial eyelash of claim 1, wherein a color of the first plastic sheet is different from a color of the second plastic sheet.

8. A method of manufacturing an artificial eyelash, comprising:
forming a first shape by cutting out a plurality of first strands integrated with a first base portion connected to one end of the first strands to support the first strands from a first plastic sheet having a certain thickness;
forming a second shape by cutting out a plurality of second strands integrated with a second base portion connected to one end of the second strands to support the second strands from a second plastic sheet having a certain thickness; and
forming a third shape, in which the first shape and second shape are combined, by adhering one surface of the first base portion to one surface of the second base portion.

9. The method of claim 8, further comprising adhering at least one strand of monofilament to a side surface or an upper surface of the first and second base portions.

10. The method of claim 9, further comprising deforming the monofilament to be in a circular arc shape.

11. The method of claim 9, further comprising applying an adhesive to the monofilament.

12. The method of claim 8, further comprising rolling up the third shape in an arrangement direction of the first and second strands such that the first and second strands are bent.

13. The method of claim 8, wherein a pattern of the first strands is different from a pattern of the second strands.

14. The method of claim 13, wherein a direction in which the first strands are stretched from the first base portion is different from a direction in which the second strands are stretched from the second base portion.

15. The method of claim 8, wherein the forming of the first shape and the forming of the second shape are performed by using a laser cutter.

16. The method of claim 15, wherein the laser cutter uses one of an ultraviolet (UV) laser, a CO₂ laser, and a fiber laser.

17. The method of claim 8, wherein the forming of the first shape and the forming of the second shape are performed by using a cutting press.
